(19) United States
(12) Patent Application Publication
(10) Pub. No.: US 2014/0083595 A1
(43) Pub. Date: Mar. 27, 2014

(54) CONSTRUCTION METHOD FOR INFLATABLE PRODUCTS

(71) Applicant: AQUA-LEISURE INDUSTRIES, INC., Avon, MA (US)

(72) Inventor: Jeffrey J. LeBlanc, East Greenwich, RI (US)

(73) Assignee: AQUA-LEISURE INDUSTRIES, INC., Avon, MA (US)

(21) Appl. No.: 14/036,823

(22) Filed: Sep. 25, 2013

Related U.S. Application Data
(60) Provisional application No. 61/705,313, filed on Sep. 25, 2012.

(51) Int. Cl. B29C 65/08; B29C 65/02

(52) U.S. Cl. CPC B29C 65/08; B29C 65/02
USPC 156/73.1; 156/290

(57) ABSTRACT

According to one aspect, embodiments of the invention provide a method for manufacturing an inflatable device, the method comprising positioning a layer of mesh fabric material onto a surface of a first layer of thermoplastic material, the mesh fabric material comprising a plurality of openings, positioning a second layer of thermoplastic material over the layer of mesh fabric material to sandwich the portion of mesh fabric material between the first and second layers of thermoplastic material, and adhering the first layer of thermoplastic material to the second layer of thermoplastic material through the plurality of openings in the mesh fabric material.

### CROSS-REFERENCE TO RELATED APPLICATIONS

This application claims priority under 35 U.S.C. §119(e) to U.S. Provisional Application 61/705,313, titled “CONSTRUCTION METHOD FOR INFLATABLE PRODUCTS,” filed on Sep. 25, 2012, which is hereby incorporated by reference in its entirety.

### BACKGROUND OF THE INVENTION

1. Field of the Invention

At least one example in accordance with the present invention relates generally to the manufacture of inflatable products, and more specifically, to inflatable products constructed with a mesh fabric material attached to a thermoplastic material.

2. Discussion of Related Art

Inflatable products include mattresses and floats for use at the pool or beach, camping gear, leisure furniture, and the like. These products may comprise an inflatable bladder or inflatable buoyant member that is covered partially or completely by a mesh fabric material. The bladder may be constructed from a thermoplastic material, such as polyvinyl chloride (PVC), and may be shaped to define the perimeter of a mattress or float. For example, the bladder may be shaped generally like an oval, a figure “8,” or a hexagon, and may further include an opening in the center. The mesh fabric material may be constructed from a polyester fabric or any other suitable fabric, and may be configured to extend across the opening. The mesh fabric material may extend over the top of the bladder, over the bottom of the bladder, or over the entire bladder.

Current methods for manufacturing such an inflatable product involve cutting the mesh fabric material into the appropriate shape, and then sewing the edge of the mesh material directly to the bladder. This method has serious disadvantages, including the following:
(1) It is difficult to control the sewing line so that it follows the exact shape of the bladder. This often results in a product with a less than optimum appearance.
(2) It is not uncommon to accidently pierce the bladder with the sewing needle. This causes air to leak from the bladder.
(3) The inflatable bladder is relatively heavy, making the sewing process awkward and time-consuming

It is therefore an object of the instant invention to provide an improved method for securing the mesh fabric material to the thermoplastic material forming the bladder by using a welding technique rather than sewing. However, welding polyester and other mesh fabric materials directly to thermoplastic material, such as PVC, is often not possible. In fact, under current technological methods, PVC will weld satisfactorily only to PVC. This invention overcomes this problem by sandwiching the mesh fabric material between two layers of thermoplastic material, and then welding the two layers of thermoplastic material to each other through the openings or holes in the mesh fabric material, as explained further below. The openings or holes in the mesh fabric material allow the two layers of thermoplastic material to bond together to provide a secure attachment of the mesh material to the bladder.

### SUMMARY

One or more aspects in accordance with the present invention are directed to a method for manufacturing an inflatable device.

In one aspect, the method for manufacturing an inflatable device comprises positioning a layer of mesh fabric material onto a surface of a first layer of thermoplastic material, the mesh fabric material comprising a plurality of openings, positioning a second layer of thermoplastic material over the layer of mesh fabric material to sandwich the mesh fabric material between the first and second layers of thermoplastic material, and adhering the first layer of thermoplastic material to the second layer of thermoplastic material through the plurality of openings in the mesh fabric material.

According to one embodiment, adhering comprises heat welding. According to another embodiment, adhering comprises high frequency welding.

According to one embodiment, adhering creates a first seam at a first location of an inflatable device. According to another embodiment, the method further comprises adhering a third layer of thermoplastic material directly to the first layer of thermoplastic material to form a second seam adjacent to the first seam at the first location. In another embodiment, the method further comprises forming a third seam at a second location of the inflatable device by adhering the first layer of thermoplastic material to the third layer of thermoplastic material. In one or more embodiments, the second location is disposed near an outer perimeter of the inflatable device. In some embodiments, the first location is disposed near an interior edge of the inflatable device.

According to another embodiment, the first and third layers of thermoplastic materials are adhered together to form at least one inflatable bladder. According to a further embodiment, the mesh fabric material extends across the surface of the first layer of thermoplastic material and the method further comprises adhering the third layer of thermoplastic material to the first layer of thermoplastic material through the plurality of openings in the mesh fabric material at a second location of the inflatable device. In another aspect, adhering the third layer of thermoplastic material to the first layer of thermoplastic material through the plurality of openings in the mesh fabric material creates a seam within the at least one inflatable bladder.

### BRIEF DESCRIPTION OF THE DRAWINGS

The accompanying drawings are not intended to be drawn to scale. In the drawings, each identical or nearly identical component that is illustrated in the various FIGS. is represented by a like numeral. For purposes of clarity, not every component may be labeled in every drawing. In the drawings:

FIGS. 1A and 1B are top views of a flotation device constructed from a method in accordance with aspects of the present invention;

FIG. 2 is an exploded perspective view of a flotation device constructed from a method in accordance with aspects of the present invention;

FIG. 3 is a cross-sectional diagram of a portion of a flotation device constructed from a method in accordance with one aspect of the present invention; and

FIG. 4 is a cross-sectional diagram of a portion of a flotation device constructed from a method in accordance with another aspect of the present invention.

### DETAILED DESCRIPTION OF THE INVENTION

For the purposes of illustration only, and not to limit the generality, the present disclosure will now be described in detail with reference to the accompanying figures. This disclosure is not limited in its application to the details of construction and the arrangement of components set forth in the following description or illustration in the drawings. The disclosure is capable of other embodiments and of being practiced or being carried out in various ways. Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

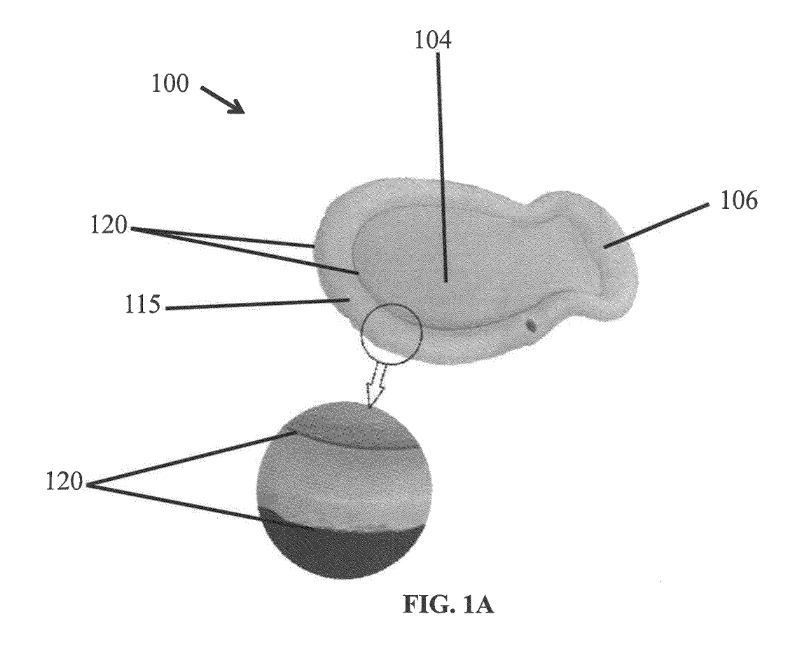

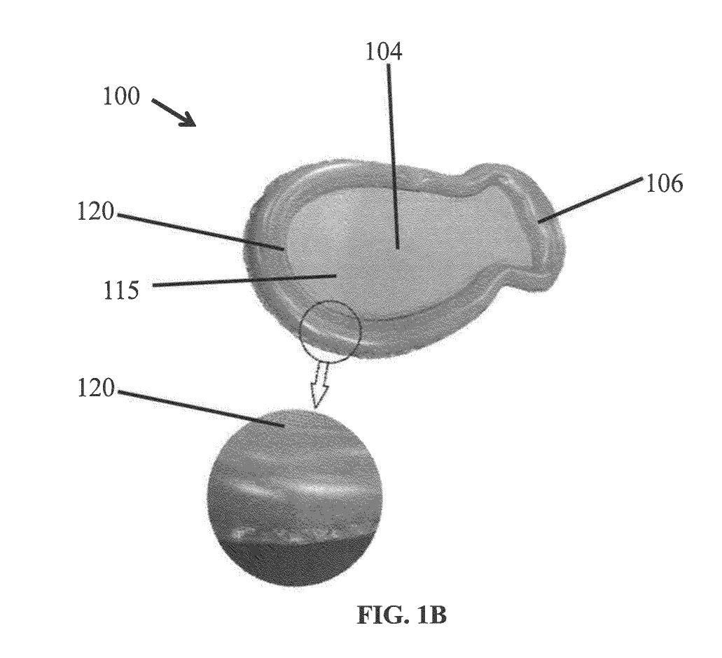

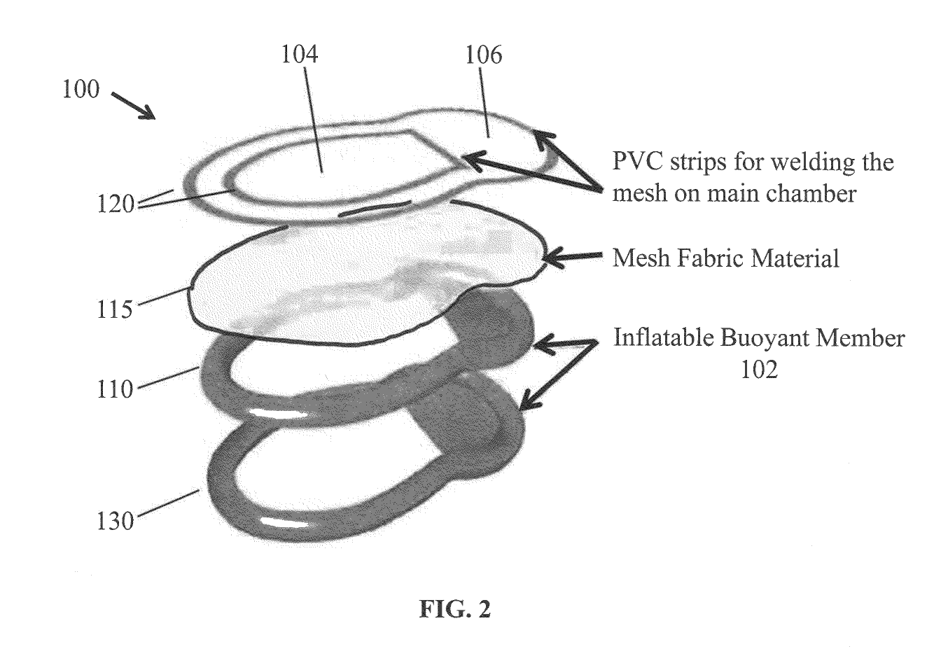

FIGS. 1A, 1B, and 2 illustrate top views and an exploded view, respectively, of one or more embodiments of an inflatable device construction 100 in accordance with the present invention. The inflatable device construction may mitigate the attachment method problems outlined above and may provide a more reliable and better quality device that is useful for one or more aquatic activities.

The inflatable device construction 100 may include a first layer of thermoplastic material 110, a second, partial layer of thermoplastic material 120, a layer of mesh fabric material 115 interposed between the first layer 110 and the second, partial layer 120 of thermoplastic material, and a third layer of thermoplastic material 130 attached to the first layer of thermoplastic material 110. The first and third layers of thermoplastic material 110 and 130 may be of similar size and shape and may be attached to each other to form an inflatable bladder or buoyant member 102. It will be appreciated by one of skill in the art that the inflatable device may be any one of a plurality of shapes or sizes, and may contain one or more inflatable bladders or buoyant members shaped and sized in various configurations.

The inflatable device construction 100 may include an opening 104 for inclusion of a seat member that may be constructed from one or more layers of the mesh fabric material 115. The inflatable bladder or buoyant member 102, in cooperation with the seat member constructed from the mesh fabric material, may function to support the weight of a user and keep the user afloat while the inflatable device is positioned in the water. The inflatable device may further include a headrest portion 106 that is constructed from the first and third layers of thermoplastic material 110 and 130, and that may itself be inflatable.

The second, partial layer of thermoplastic material 120 may consist of two separate and continuous ribbon-like strips. In some embodiments, the strips may not be continuous, and may instead be formed from one or more separate pieces of material. As illustrated in FIG. 2, one strip of the second, partial layer of thermoplastic material 120 may be constructed and configured to follow the outline of the outer perimeter of the first layer of thermoplastic material 110. As shown in FIG. 2, this outer strip may be shaped generally like a figure “8.” Another inner strip of the second, partial layer of thermoplastic material 120 is positioned near the perimeter of the opening 104 of the inflatable device. The inner strip may be shaped like a truncated oval. The strips of thermoplastic material may be of any shape and dimension that is permits their attachment to one or more other layers of thermoplastic material through the openings in the mesh fabric material using the attachments methods discussed below.

In one embodiment, each layer or partial layer of thermoplastic material 110, 120, and 130 may be made from polyvinyl chloride (PVC). However, it is to be appreciated that the layers of thermoplastic material may be made of any type of plastic, such as laminated PVC, that is capable of being welded by known techniques.

The mesh fabric material 115 may include a plurality of openings or holes (not shown). The plurality of openings or holes may be of any size, shape, or dimension, provided the mesh material is suitable to allow welding the two layers of thermoplastic material to each other through the mesh. In various embodiments, the mesh fabric material 115 is made from polyester, such as a woven polyester mesh. However, it is to be appreciated that the mesh fabric material 115 may be made of any type of man-made or natural substantially-flexible material as long as the material has a plurality of openings therethrough and is adaptable to the purpose of the invention disclosed herein.

A three-step construction method in accordance with one aspect of the disclosure comprises the following: first, mesh fabric material 115 may be placed between the first layer of thermoplastic material 110 and the PVC strips that form the second, partial layer of thermoplastic material 120. The second step may include attaching these layers together, for example, by using a welding technique. The layers may be attached to each other at more than one location on the inflatable device, for example, at both the outer perimeter and the interior or interior edge of the inflatable device. For example, the layers may be attached at the outer perimeter and the interior of thermoplastic layer 110. A third step may include attaching the third layer of thermoplastic material 130 to the first layer of thermoplastic material 110 to form the inflatable bladder or buoyant member 102 of the inflatable device.

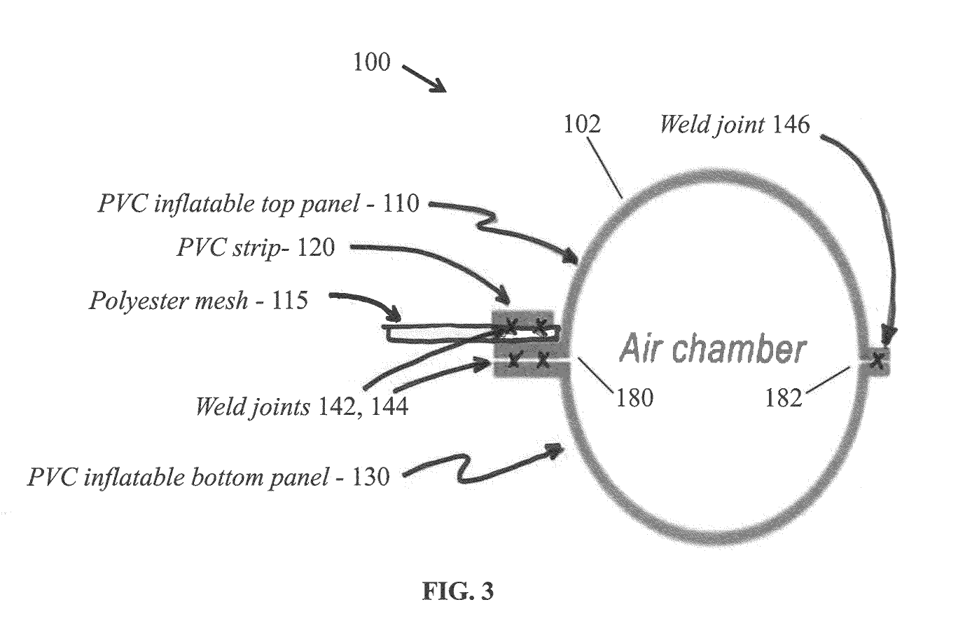

FIG. 3 illustrates a cross-section of a portion of the inflatable bladder or buoyant member 102 of assembled inflatable device construction 100 of FIG. 2. According to one or more embodiments, the mesh fabric material 115 is first interposed between the first and second thermoplastic layers 110 and 120. The first thermoplastic layer 110 and one of the strips of partial thermoplastic layer 120 are then adhered to each other through the openings in the mesh fabric material 115 to form a first seam 142. For example, the top surface of the first layer of thermoplastic material 110 may be adhered to the bottom surface of the strip of second, partial layer of thermoplastic material 120 through the openings in the mesh fabric material 115. As used herein, the terms “weld joint” and “seam” may be used interchangeably. In certain embodiments, the first seam 142 may function to secure the mesh fabric material 115 between the first and second layers of thermoplastic material 110 and 120. In some instances, the mesh fabric material 115 may be attached so that it is embedded into the first and second layers of the thermoplastic material 110 and 120. In various embodiments, the first and second layers of thermoplastic material 110 and 120 may be attached to each other through one or more welding techniques known in the art. For example, in some embodiments, one or more layers of thermoplastic material may be attached to each other by using a heat welding technique. In other embodiments, thermoplastic layers may be attached using high-frequency welding. The welding may be performed at a predetermined temperature for a predetermined length of time sufficient for the first and second layers of thermoplastic material 110 and 120 to permanently bond to each other through the openings in the mesh fabric material 115. For example, welding may raise the temperature of a portion of the first and second layers of thermoplastic material 110 and 120 located adjacent the mesh fabric material 115 above their melting temperature. Specific temperatures and times may be dependent upon the thicknesses and types of materials used in constructing the inflatable device. Preferred values may be readily selected by those skilled in the art once the specific thermoplastic material and mesh fabric material have been selected. For example, depending on the size of the welding area, in some embodiments the wattage of electricity used in high frequency welding may range from about 35 K watts to about 150 K watts. Specific temperatures and times may also be dependent upon the design or configuration of the inflatable device. In one or more embodiments, welding may be performed at one or more locations on the inflatable device. In certain instances, welding may be performed at one or more locations on the inflatable device to form a single seam. The resulting seam may be formed by welding continuously, or, in the alternative, may be done at individual locations formed near each other.

As illustrated in the embodiment of FIG. 3, the third layer of thermoplastic material 130 may be attached directly to the first layer of thermoplastic material 110 to form a second seam 144 at a first location 180 on the inflatable device using any of the attachment methods discussed above. For example, the bottom surface of the first layer of thermoplastic material 110 may be attached to the top surface of the third layer of thermoplastic material 130. In certain instances, the second seam 144 is positioned directly adjacent to the first seam 142 formed by the fusion of mesh fabric material 115 and the first and second layers of thermoplastic material 110 and 120. According to some embodiments, the first location 180 may be positioned near the interior or interior edge of the inflatable device, such as by defining the perimeter of the seat opening 104. In various embodiments, the first and second seams 142 and 144 may be formed simultaneously.

The third layer of thermoplastic material 130 may also be attached to the first layer of thermoplastic material 110 to form a third seam 146 at a second location 182 on the inflatable device. The third seam 146 at the second location 182 may be positioned at the outer perimeter of the inflatable device. According to certain embodiments, one surface of the first layer of thermoplastic material 130 may be attached to an opposed surface of the third layer of thermoplastic material 110, as discussed above and as shown in FIG. 3 at the second location 182. In some embodiments, the second location 182 may be positioned near the perimeter of the inflatable device, and may define the outer perimeter of the inflatable bladder or buoyant member 102. The second seam 144 formed between the first and third layers of thermoplastic material 110 and 130 at the first location 180, in combination with the third seam 146 at the second location 182, may form the inflatable bladder or buoyant member 102 of the inflatable device.

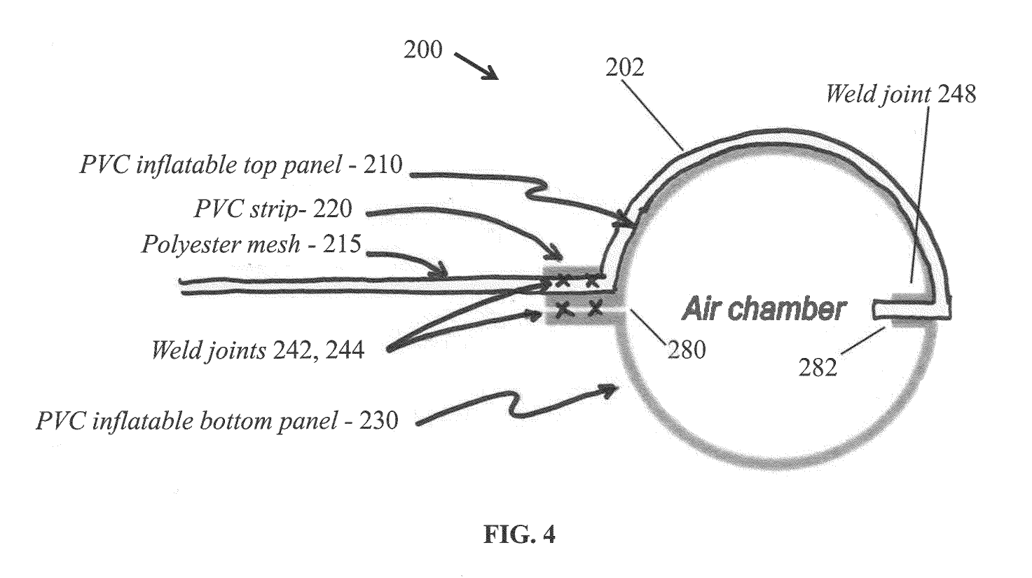

FIG. 4 illustrates a cross-section of a portion of an assembled inflatable device construction 200 in accordance with another embodiment of the present invention. The first seam 242 formed between the mesh fabric material 215 and the first and second layers of thermoplastic material 210 and 220 is formed in a similar manner as discussed above with respect to FIG. 3. Likewise, the second seam 244 formed at the first location 280 is also constructed in a similar manner as discussed above. As illustrated in FIG. 4, the mesh fabric material 215 may extend across the entire top surface of the first layer of thermoplastic material 210 and may be positioned between the first and third layers of thermoplastic material 210 and 230 at a second location 282. The first and third layers of thermoplastic material 210 and 230 may then be attached to each other through the openings of the mesh material 215 to form a third seam 248 by using one or more attachment methods discussed above. As shown in FIG. 4, the third seam 248 may be positioned within the interior of the inflatable bladder or buoyant member 202. For example, the first layer of thermoplastic material 210 may be attached to the third layer of thermoplastic material 230 to form a “hidden” seam, i.e., hidden within the inflatable bladder or buoyant member 202. In various embodiments, one or more “hidden” seams may be formed first, prior to the formation of other seams at other locations on the inflatable device. For example, the third seam 248 may be formed before the first seam 242 and/or the second seam 244. In certain instances the second location 282 may be positioned along the outer perimeter of the inflatable device. In accordance with some embodiments, the second seam 244 formed between the first and third layers of thermoplastic material 210 and 230 at the first location 280, in combination with the third seam 248 at the second location 282, may form the inflatable bladder or buoyant member 202 of the inflatable device.

According to one or more embodiments, the construction method disclosed herein may be used to position and attach the mesh fabric material at one or more locations on the inflatable device. For example, the mesh fabric material may be positioned to extend across the entire top surface of the first layer of thermoplastic material and across an opening of the inflatable device. In this embodiment, the mesh fabric material may be attached to the first layer and the second, partial layer of thermoplastic material at a first location located near the perimeter of the inflatable device and at a second location located near the interior of the inflatable device. In alternative embodiments, the mesh fabric material may be positioned to extend across only a portion of the first layer of thermoplastic material. For example, the mesh fabric material may be configured to extend across an opening of the inflatable device and therefore may be attached to the first and second layers of thermoplastic material near the interior of the inflatable device.

In still other embodiments, the mesh fabric material may be positioned to extend across the entire surface of the first and third layers of thermoplastic material, and may further extend across one or more openings of the inflatable device. For example, the mesh fabric material may entirely envelop the inflatable bladder or buoyant member, in which one or more seams may be formed on the underside of the device. For example, one or more strips of the second layer of thermoplastic material may be positioned on the underside of the inflatable device and may be attached to the third layer of thermoplastic material in a similar manner as discussed above. In alternative embodiments, the mesh fabric material may envelop only the inflatable buoyant member and not the opening.

According to some embodiments, the construction method described above may be used at one or more locations on the inflatable buoyant member of the inflatable device. For example, a valve may be used to inflate the buoyant member and the method may be used to form a seal constructed from the mesh fabric material and the thermoplastic layers positioned around the perimeter of the valve.

Having thus described at least one embodiment of the present disclosure, various alterations, modifications, and improvements will readily occur to those skilled in the art. Such alterations, modifications, and improvements are intended to be within the scope and spirit of the disclosure. Accordingly, the foregoing description is by way of example only and is not intended to be limiting. The disclosure's limit is defined only in the following claims and equivalents thereto.

What is claimed is:

1. A method for manufacturing an inflatable device, comprising:
positioning a layer of mesh fabric material onto a surface of a first layer of thermoplastic material, the mesh fabric material comprising a plurality of openings;
positioning a second layer of thermoplastic material over the layer of mesh fabric material to sandwich the mesh fabric material between the first and second layers of thermoplastic material; and
adhering the first layer of thermoplastic material to the second layer of thermoplastic material through the plurality of openings in the mesh fabric material.

2. The method of claim 1, wherein adhering comprises heat welding.

3. The method of claim 1, wherein adhering comprises high frequency welding.

4. The method of claim 1, wherein the adhering creates a first seam at a first location of an inflatable device.

5. The method of claim 4, further comprising adhering a third layer of thermoplastic material directly to the first layer of thermoplastic material to form a second seam adjacent to the first seam at the first location.

6. The method of claim 5, further comprising forming a third seam at a second location of the inflatable device by adhering the first layer of thermoplastic material to the third layer of thermoplastic material.

7. The method of claim 6, wherein the second location is disposed near an outer perimeter of the inflatable device.

8. The method of claim 7, wherein the first location is disposed near an interior edge of the inflatable device.

9. The method of claim 5, wherein the first and third layers of thermoplastic materials are adhered together to form at least one inflatable bladder.

10. The method of claim 9, wherein the mesh fabric material extends across the surface of the first layer of thermoplastic material and the method further comprises adhering the third layer of thermoplastic material to the first layer of thermoplastic material through the plurality of openings in the mesh fabric material at a second location of the inflatable device.

11. The method of claim 10, wherein adhering the third layer of thermoplastic material to the first layer of thermoplastic material through the plurality of openings in the mesh fabric material creates a seam within the at least one inflatable bladder.
